(19) United States
(12) Patent Application Publication
(10) Pub. No.: US 2009/0150212 A1
(43) Pub. Date: Jun. 11, 2009

(54) Method for identifying entities exhibiting patterns of interest related to financial health

(76) Inventors: Gregg Katsura Steuben, Ballston Lake, NY (US); Kareem Sherif Aggour, Niskayuna, NY (US); Michael Andrew Woellmer, Troy, NY (US); Benjamin Thomas Verschueren, Niskayuna, NY (US); Bethany Kniffin Hoogs, Niskayuna, NY (US); Christina Ann LaComb, Schenectady, NY (US); Mark Richard Gilder, Clifton Park, NY (US); Deniz Senturk-Doganaksoy, Danbury, CT (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/999,351

(22) Filed: Dec. 5, 2007

(51) Int. Cl. G06Q 10/00

(52) U.S. Cl. 705/10; 705/1; 705/35

(57) ABSTRACT

A method of identifying a set of entities based on a pattern of interest is provided. The method includes identifying a reference entity and identifying one or more alert categories indicative of a pattern of interest in the reference entity over a time period of interest. The method further comprises determining a matching percentage of the pattern of interest exhibited by the reference entity, in one or more entities comprising the set of entities based on the one or more alert categories. The method further comprises identifying one or more of the entities comprising the set of entities that exhibit one or more of the patterns of interest exhibited by the reference entity, based on the matching percentage.

### BACKGROUND

The invention relates generally to monitoring the financial health of entities and more particularly to a method for identifying a set of entities that exhibit one or more patterns of interest related to financial health.

Understanding the financial health of a business entity or a company is an important factor in evaluating a potential business interaction with that company or entity. An understanding of a company's financial health can be used to help evaluate the risks involved in doing business with that company, and can form a basis for predicting the expected benefits from the potential business relationship or transaction. However, fraudulent financial filings by the company can provide a misleading picture of the financial health of a company. Companies that engage in such fraudulent behavior can collapse in ways not reflected by the apparent financial health reflected by their financial information.

Financial analysts, such as managers of investment portfolios and analysts working for companies extending credit, and loan officers, make decisions every day based upon perceptions of a company's financial health. Their basis for this perception is generally in large part taken from information on the company's financial statements. Taken at its simplest, such financial analysts look for any financial data that doesn't seem to fit in, either because it represents an unusual financial circumstance for the company (which may indicate poor financial health), or because it doesn't conform to the analyst's existing knowledge of the company's financial circumstances (which may indicate improper or fraudulent financial reporting). Such ‘out of the ordinary’ financial data are referred to generally as ‘anomalous data’.

A financial analyst would like to detect any financial anomalies as early as possible and with as great a degree of confidence as possible. Properly recognized and understood, financial anomalies can act as early warning signs of financial decline or fraud, which can allow an analyst to avoid transactions that are undesirable by recognizing developing problems as they occur or identifying false or misleading financials before the time where the company's dire financial straits become apparent due to earnings shortfalls, scandals or bankruptcy.

It would be desirable for a financial analyst to analyze the patterns of interest in the financial filings of an entity that often precede fraud or potential default. In addition, it would be desirable for a financial analyst to search for and identify entities that are potentially committing fraud or that may default in the near future by analyzing these patterns of interest. Further, it would be desirable for a financial analyst to identify and characterize entities that exhibit particular patterns of interest related to the financial health of the entity.

### BRIEF DESCRIPTION

Embodiments of the present invention address these and other needs. In one embodiment, a method of identifying a set of entities based on a pattern of interest is provided. The method includes identifying a reference entity and identifying one or more alert categories indicative of a pattern of interest in the reference entity over a time period of interest. The method comprises determining a matching percentage of the pattern of interest exhibited by the reference entity, in one or more entities comprising the set of entities, based on the one or more alert categories. The method further comprises identifying one or more of the entities comprising the set of entities that exhibit one or more of the patterns of interest exhibited by the reference entity, based on the matching percentage.

### DRAWINGS

The application file contains at least one drawing executed in color. Copies of this patent application with color drawing(s) will be provided by the Office upon request and payment of the necessary fee.

These and other features, aspects, and advantages of the present invention will become better understood when the following detailed description is read with reference to the accompanying drawings in which like characters represent like parts throughout the drawings, wherein:

FIG. 1 is a flow diagram of general process steps for identifying a set of entities based on a pattern of interest, in accordance with one embodiment of the invention; and

FIGS. 2-5 show various screen displays that may be presented to a user, to enable a user to identify a set of entities that exhibit a particular pattern of interest.

### DETAILED DESCRIPTION

Disclosed herein is a technique for identifying a set of entities that exhibit one or more patterns of interest related to the financial health of an entity. The patterns of interest may include, for example, financial decline, likelihood of fraud, financial credit or investment risk and good credit or investment prospect associated with the entity. In one embodiment, and as will be described in greater detail below, the financial health of an entity is evaluated by analyzing one or more financial metrics related to the entity over a period of time. In a particular embodiment, the entity of interest to a financial analyst or other investigator is referred to as the ‘reference’ entity and the financial health of the reference entity is evaluated by comparing one or more financial metrics related to the reference entity to the financial metric values related to the reference entity at earlier time periods, as well as to the financial metric values related to one or more peer entities related to the reference entity. Also, as discussed herein, a ‘financial metric’ may be any piece of financial data that is associated with the performance or operation of an entity over a particular time period. For instance, a classic financial metric is net income. Other financial metrics include, but are not limited to: total revenue; inventory on hand; capital expenses; interest payments; debt; and earnings before interest, taxes, depreciation and amortization (EBITDA).

While these and many other financial metrics are known in the art, their usage to identify financial anomalies has become progressively more difficult over time. As financial accounting has become increasingly complex, it has become more difficult to systematically identify financial statement fraud or financial decline. Even when a broad scope of well-considered financial metrics is used to analyze the financial health of a company, it can still be difficult to define whether a metric's value is higher or lower than it ought to be. Rather than simply calculating the value of the metric, the analyst would like to determine whether the financial metric's value is anomalous. To complicate matters further, the definition of an anomaly may change from one financial metric to the next. Limitations on anomalous values may also vary based on factors such as the size of the entity, the industry in which the entity operates, and the passage of time. In particular, changes over time can reflect both changes in the operation of the entity, as well as changes in the overall economic environment.

In order to account for these variations and determine whether or not a given value for a financial metric for an entity is outside an expected range (i.e., anomalous), context information is used to form a basis for the analysis of the entity's financial metric data. This context information can be taken from two primary sources: the entity's past performance, and the performance of the entity's peers. By using such context information to quantify the typical amount of variation present within the industry or within the entity's own performance, it is possible to systematically and rigorously compare current financial metric data to context data and accurately assess the level of anomalous financial data in an entity's financial statements. Illustrative examples of anomalous financial data may include, but are not limited to, unusually high debt, unusually high interest rates, deteriorating operating cash flow position, deteriorating earnings, deteriorating margins, sharp increase in accounts receivable relative to sales, sharp decline in sales volume, high inventories to sales ratio, rapid inventory growth, unusual sources and use of cash such as unusually high cash from financing versus operations, bad debt reserves not correlated with revenues, unusual drop in unearned revenue, unusual increase in unbilled receivables/revenue, unusual increase in unearned revenue compared to sales, rapid increase in earnings, source of growth through acquisitions, unusually high capital spending, unusually high intangibles, performance otherwise atypical for company and performance otherwise atypical in industry.

As noted above, context information may be used to properly evaluate the degree to which a given financial metric is anomalous. In order to have an effective evaluation, the context data is selected to be appropriately relevant to the target financial metric for the entity. When selecting the appropriate context data over the time domain, it is generally desirable to look at the closest data available to the time period of interest. Since the time period of interest is usually the most recent data available, the appropriate scope of time to consider is a sequence of the most recent financial data available for the entity, for example, the data corresponding to the last 3 years, in one embodiment. By establishing the appropriate context, both in time and across the industry to the peers of the reference entity, the need for a subjective assessment as to whether a given financial metric is anomalously high or low can be avoided, and objective and automatic calculation can be made to detect and quantify financial anomalies. Note that it is the case that a value can be either anomalously high, or anomalously low. While there generally is a particular direction that is recognized as being the preferable trend in a value (e.g., it is generally better to have high revenues than low revenues), it should be noted that anomalies may be identified regardless of their polarity. This allows for the evaluation of data that appears to be “too good to be true” and may in fact represent a misleading or suspicious value for a financial metric. Further, anomalies may also be detected based on identifying a simultaneous behavior of more than one financial metric.

In order to evaluate whether or not a given metric is an anomaly, an ‘anomaly score’ for that financial metric for the entity can be calculated. The technical effect of calculating anomaly scores is to allow systems to objectively and automatically detect circumstances that can be used to identify financial data that indicate unhealthy or fraudulent finances for an entity. For a given entity, each financial metric can be analyzed to determine the degree to which the value for that metric is different from the appropriate context data for that entity and that metric. Depending on the nature of the context used (i.e., over time as opposed to across an industry), there are two different types of anomaly scores that can be calculated: the “anomaly-within” score, and the “anomaly-between” score. “Anomaly-within” scores are scores calculated based upon the set of data representing a particular financial metric for a reference entity taken over different time periods. For instance, this data may represent financial metrics from successive fiscal quarters. The target value is generally the most recent value of the metric. In this way, anomaly-within scores measure a given entity's financial data against its own past performance. Additionally, “anomaly-between” scores are scores derived based upon financial metric data related to a reference entity as well as a group of peer entities, all for the same time period. This data may represent the performance of a group of similarly situated entities all considered in a particular fiscal quarter. In other words, the anomaly-between scores measure a given entity's financial data against the performance of its peer entity group. One statistical technique to evaluate the degree to which a particular value in a group is an outlier, i.e. is anomalous, is to calculate a ‘Z-score’ for the value in the group. Typical Z-scores are based upon a calculation of the mean and the standard deviation of the group. Details of the implementation and calculation of “anomaly-within” and “anomaly-between” scores are described in further detail in co-pending U.S. patent application Ser. No. 11/022,402 entitled “Method and System for Anomaly Detection in Small Datasets”, filed on 27 Dec. 2004, which was published as US Patent Application Publication Number 2006/0031150A1 on 9 Feb. 2006, the entirety of which is hereby incorporated by reference herein.

As will be discussed in greater detail below, embodiments of the present invention enable the characterization of a set of entities exhibiting a pattern of interest related to the financial health of an entity, based on one or more ‘alert signals’ or ‘red flags’ that are triggered in the event of an anomalous value detected for the financial metric for the entity. For example, an alert signal or a red flag might be triggered in the event of anomalously high revenue combined with anomalously high inventory value. Accordingly, by combining individual information, the decision to signal a red flag may be based on bringing together information from several (potentially different) sources, which increases the likelihood of catching an actual event and may be used to minimize false alarms. Furthermore, identifying a set of entities that exhibit one or more patterns of interest indicative of unhealthy or fraudulent finances and/or fraudulent behavior (or any other behavior that may impact an entity's performance) before the act becomes general knowledge provides valuable competitive intelligence for investors to minimize their portfolio and/or maximize risk.

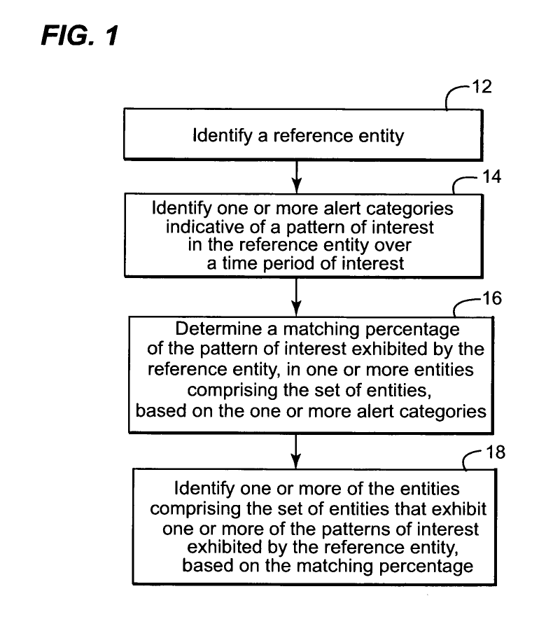

FIG. 1 is a flow diagram of general process steps for identifying a set of entities based on a pattern of interest, in accordance with one embodiment of the invention. In one embodiment, the set of entities may include one or more peer entities selected from the same industrial segment as the reference entity. The patterns of interest may include, but are not limited to, likelihood of fraud, financial credit or investment risk and good credit or investment prospect associated with the reference entity. Further, the patterns of interest may also include declining financial health or warning signs of misleading financials related to the reference entity, such as, for example, unusually low margins, unusually low earnings, significant decline in sales volume, significant decline in operating cash flow position and frequent acquisitions.

Referring to FIG. 1 now, in step 12, a reference entity is identified. In step 14, one or more alert categories indicative of a pattern of interest in the reference entity, are identified over a time period of interest. In one embodiment, the alert categories may be identified based on the presence of one or more alert signals/red flags over the time period of interest. The alert signals may be used to highlight areas in the financial filings/financial metrics in the reference entity that may be of particular interest. In a particular embodiment, and as will be described in greater detail below, the alert signals may be represented as a visual or a textual representation of the pattern of interest exhibited by the reference entity over the time period of interest. Further, in step 14, a time period of interest for analyzing a set of entities that exhibit one or more patterns of interest in the reference entity, may also be specified.

In step 16, a matching percentage of the pattern of interest exhibited by the reference entity, in one or more entities comprising the set of entities, is determined, based on the one or more alert categories. In one embodiment, the matching percentage is determined based upon a similarity function and a time period weight assigned to a particular time interval in the reference entity and each entity in the set of entities under consideration. In a particular embodiment, the ‘similarity function’ is calculated by comparing an alert value for an alert category at a particular time interval in the reference entity, with an alert value for the alert category at the corresponding time interval in each entity comprising the set of entities. An explicit alert value match is assigned a value of 1. A partial match is assigned a value greater than 0 and less than 1. No match is counted as zero. In one embodiment, the ‘time period weight’ is calculated by assigning a particular weight to an alert value for an alert category, during a time interval. For example, in one embodiment, a higher weight is assigned to an alert value occurring at a more recent time interval in an alert category, than an alert value that occurred at an earlier time interval in the alert category.

In step 18, one or more entities comprising the set of entities that match the pattern of interest exhibited by the reference entity are identified based on the matching percentage. In one embodiment, a minimum matching/similarity threshold for each entity comprising the set of entities that match the pattern of interest in the reference entity may be specified. In a particular embodiment, one or more entities whose matching percentage exceeds the minimum matching threshold are identified as the set of entities that match the pattern of interest exhibited by the reference entity. In a particular embodiment, and as will be described in greater detail below, the set of entities along with the matching percentage of the pattern of interest at a particular time interval are displayed to a user.

In accordance with another embodiment of the present invention, a set of entities that match a specified pattern of interest may be identified. In a particular embodiment, the pattern of interest may be specified by identifying one or more alert categories related to the set of entities and one or more time periods (a near-term period and a long-term period) of interest. Further, one or more levels of intensity/thresholds for the alert categories in the near and the long-term periods of interest may also be specified. In one embodiment, the levels of intensity include specifying a percentage (for e.g., 0%, less than 50%, or 100%) of red flags that appear during the time periods of interest. The result (i.e., the set of entities that match the specified pattern of interest) may further be filtered based on the percentage. In other words, the average number of times that an alert category was triggered for each entity over either a near-term period or a long-term period may be identified, based on the specified thresholds. If both a near-term period and a long-term period of interest are specified, an intersection of the set of entities that match both the near-term period and the long-term period are identified. For example, a set of entities that match a pattern of interest based on an alert category that was triggered 50% of the time in the last four quarters may be identified by determining the percentage of times that a particular alert category (for e.g., frequent acquisitions) was triggered in the last four quarters, with the threshold of the alert category in the near-term period (for e.g., the last four quarters) being >50% and the threshold of the alert category in the long-term period (for e.g., the last twelve quarters) being <25%. Further, and as described above, the set of entities identified may be constrained as belonging to a particular type of “industrial segment”.

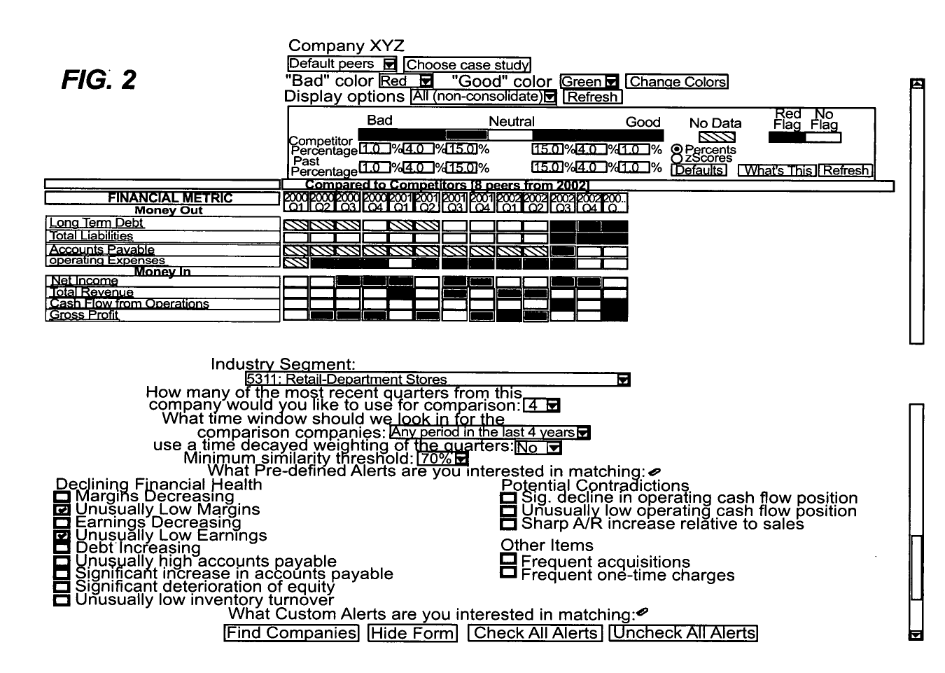

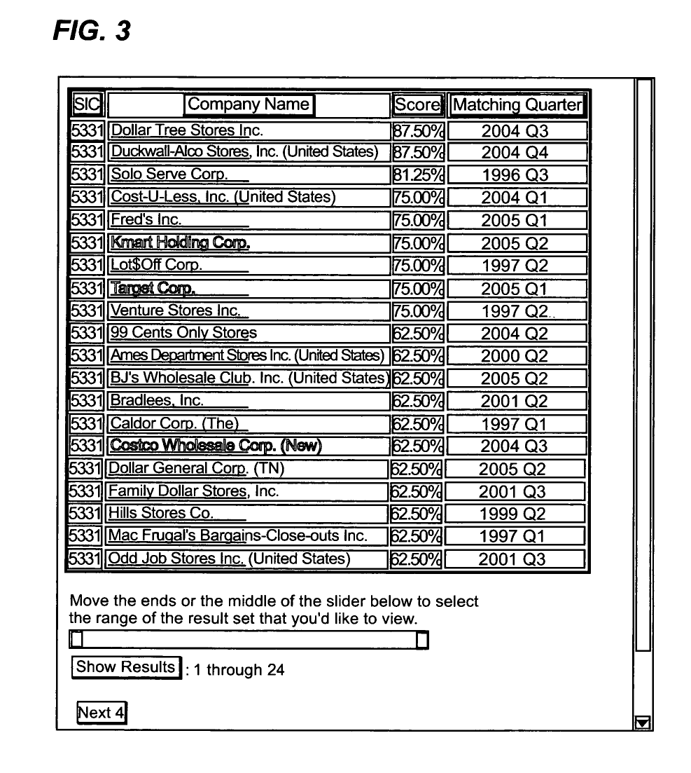

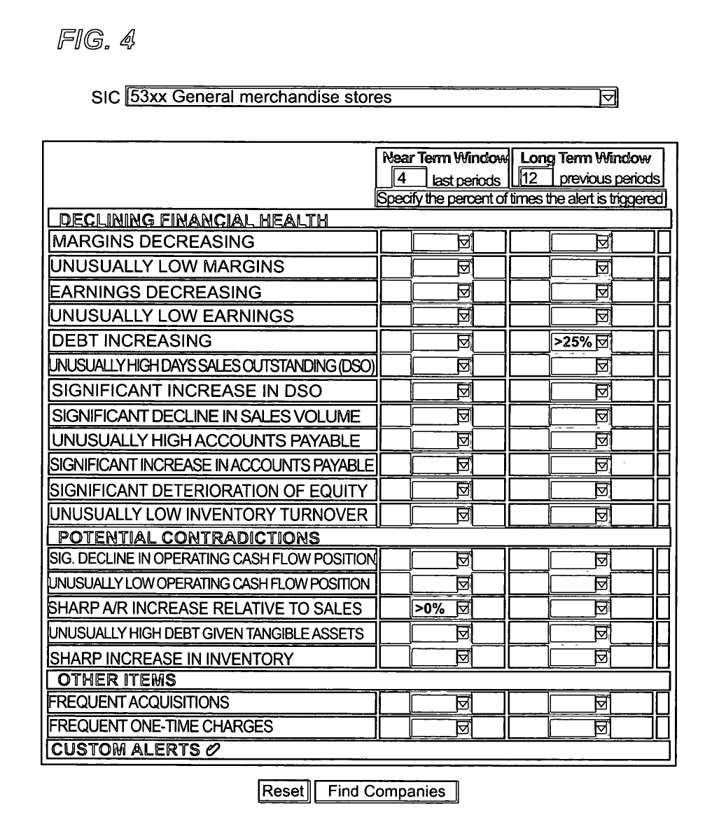

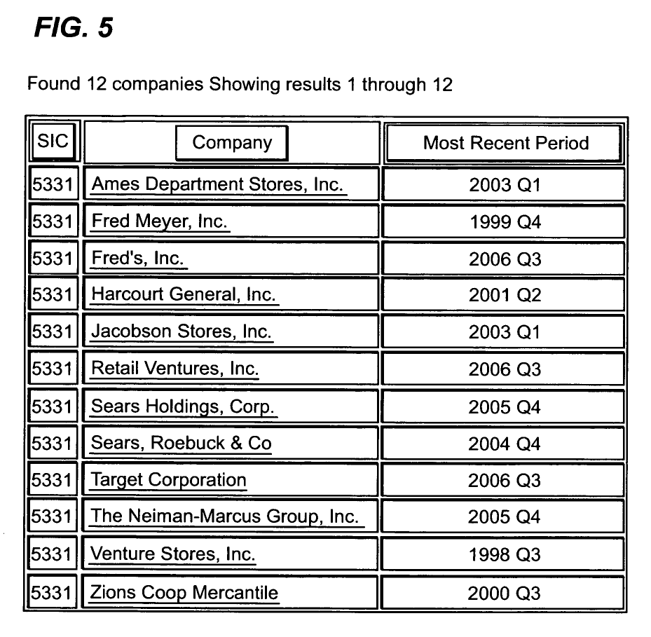

FIGS. 2-5 show various screen displays that may be presented to a user, to enable a user to identify a set of entities that exhibit a particular pattern of interest. In one embodiment, and as discussed with reference to the screen displays shown in FIG. 2 and FIG. 3 below, a set of entities that exhibit a pattern of interest in a reference entity are identified. In another embodiment, and as discussed with reference to the screen displays shown in FIG. 4 and FIG. 5 below, a set of entities that match a specified pattern of interest are identified. In one embodiment, the screen displays shown in FIGS. 2-5 are represented by a graphical user interface (GUI) to enable a user to select one or more indicator variables over time as a means for characterizing a set of entities that match a particular pattern of interest with respect to the selected indicator variables of interest, for a particular time period of interest. Further, it should be noted that the screen displays shown in FIGS. 2-5 are for illustrative purposes only and are not exhaustive of other types of displays that can be presented to a user for this embodiment or the displays that can be presented in other possible embodiments. Also, the actual look and feel of the displays can be slightly or substantially changed during implementation.

FIG. 2 shows an input screen display for permitting a user to identify a set of entities that match a particular pattern of interest exhibited by a reference entity. In one example, and as shown in the screen display of FIG. 2, the selected reference entity is the “XYZ Company” and the particular industrial segment selected is the “Retail-department stores” segment. The user may also specify a particular time period of interest (in time intervals) and identify a set of alert categories in the reference entity, that the user is interested in matching.

In one embodiment, and as mentioned above, the alert categories may be identified based on a presence of one or more alert signals/red flags over the time period of interest. Further, and as mentioned above, the alert signal may be represented as a visual and/or textual representation of the detected anomaly exhibited by an entity over time. In a particular embodiment, the alert signal may be identified based upon a degree of frequency, direction, severity or persistence of the detected anomaly. In one embodiment, the frequency represents a rate of occurrence of the detected anomalous value, the direction represents a trend in the detected anomaly with respect to a population, the severity represents the amount of deviation between the detected anomaly and its population and the persistence represents a continued presence of the detected anomaly over a period of time. In a particular embodiment, and as shown in the screen display of FIG. 2, various color codes may further be used to represent the extent and direction of deviation. Deviation in a positive or financially healthy manner, such as, for example, gross profit, may be represented by a “green color code” whereas deviation in a negative or financially unhealthy manner, such as, for example, low cash from operations, may be represented by a “red color code”. One of ordinary skill in the art will recognize that other color codes are possible for the generation and identification of alert signals in accordance with embodiments of the present invention.

Referring again to the input screen shown in FIG. 2, the user may also specify an appropriate time period of interest for analyzing the set of entities. The time period of interest may include, for example, the number of quarters to be used for comparison with the reference entity. The user may further specify a time period weight (such as, for example, by specifying a “time decayed weight”) for the desired number of quarters and a “minimum matching/similarity threshold”, as shown in FIG. 2.

FIG. 3 is an output screen display showing a set of entities that match a particular pattern of interest exhibited by a reference entity. As shown in FIG. 3, the set of entities along with the matching pattern of interest at a particular time interval, are displayed to a user.

FIG. 4 is an input screen display for permitting a user to identify a set of entities that match a specified pattern of interest. In one embodiment, the user specifies the type of industrial segment related to the entities to be identified, one or more alert categories, one or more time periods of interest and one or more levels of intensity/thresholds for the alert categories. As described above, the time periods of interest may further include a near-term window/period and a long-term window/period. In the particular example shown in FIG. 4, the type of industrial segment selected is the SIC Code “53xx: General Merchandise stores” segment and the alert categories, “Debt Increasing” and “Sharp A/R increase relative to sales” are selected with levels of intensity of greater than 25% long-term and greater than 0% near-term, respectively.

FIG. 5 is an output screen display of a set of entities exhibiting the specified pattern of interest. As shown in FIG. 5, a set of entities that match the specified pattern of interest along with the particular time interval in each entity in which the pattern was matched are displayed to the user.

Embodiments of the present invention have several advantages including the ability to identify entities that exhibit one or more patterns of interest indicative of the financial health of an entity. The identification of unhealthy or fraudulent finances and/or fraudulent behavior (or any other behavior that may impact an entity's performance) before the act becomes general knowledge provides valuable competitive intelligence for investors to minimize their portfolio and/or maximize risk. Further, the disclosed embodiments may also be used to identify entities with good future prospects and to modify any future service contracts with such entities. Embodiments of the present invention may also be employed by commercial lending businesses to improve the ability to assess the risk associated with current and prospective customer accounts. Thus, a user may assign appropriate covenants and terms to maximize their gain from their accounts while minimizing their risk exposure. As will be appreciated by those skilled in the art, the ability to discriminate and select good prospective accounts, and to effectively monitor the risk of existing accounts is a significant contributor to the profitability of commercial lending businesses in general. The disclosed embodiments improve the capability to perform these processes uniformly and comprehensively and enable the selection and retention of a more profitable account portfolio. The invention also enables marketers to identify potential prospects of entities/companies to loan money, as the right combination of red flags may indicate an entity in financial distress that could prove to be a good customer.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of identifying a set of entities based on a pattern of interest, the method comprising:
identifying a reference entity;
identifying one or more alert categories indicative of one or more patterns of interest in the reference entity over a time period of interest;
determining a matching percentage of the pattern of interest exhibited by the reference entity, in one or more entities comprising the set of entities, based on the one or more alert categories; and
identifying one or more of the entities comprising the set of entities that exhibit one or more of the patterns of interest exhibited by the reference entity, based on the matching percentage.

2. The method of claim 1, wherein the patterns of interest include at least one of likelihood of fraud, financial credit or investment risk and good credit or investment prospect associated with the reference entity.

3. The method of claim 1, wherein the set of entities comprise one or more peer entities that are in the same industrial segment as the reference entity.

4. The method of claim 1, further comprising specifying a time period of interest for analyzing the one or more entities comprising the set of entities.

5. The method of claim 4, wherein the one or more alert categories are identified based on a presence of one or more alert signals over the time period of interest.

6. The method of claim 5, wherein the one or more alert signals comprise at least one of a visual representation or a textual representation of the pattern of interest exhibited by the alert category over the time period of interest.

7. The method of claim 1, wherein the matching percentage is determined based upon at least one of a similarity function and a time period weight assigned to a particular time interval in the reference entity and the set of entities.

8. The method of claim 7, wherein the similarity function is calculated based upon a comparison of an alert value for an alert category at a particular time interval in the reference entity and an alert value for the alert category at a corresponding time interval in each entity comprising the set of entities.

9. The method of claim 8, wherein the time period weight is calculated based upon an alert value weight assigned to an alert category, during a particular time interval.

10. The method of claim 1, further comprising displaying the set of entities based on the matching percentage, at a particular time interval to a user.

11. The method of claim 1, wherein identifying a set of entities based on a pattern of interest further comprises specifying a pattern of interest based on one or more alert categories and identifying the set of entities that match the specified pattern of interest.

12. The method of claim 11 further comprising displaying the set of entities that match the specified pattern of interest at a particular time interval, to a user.
